(19) United States
(12) Patent Application Publication
(10) Pub. No.: US 2022/0036332 A1
(43) Pub. Date: Feb. 3, 2022

(54) Clerking Assembly

(71) Applicant: Daniel Gingerich, Campbellsville, KY (US)

(72) Inventor: Daniel Gingerich, Campbellsville, KY (US)

(21) Appl. No.: 16/942,947

(22) Filed: Jul. 30, 2020

(51) Int. Cl. G06Q 20/20; G06Q 30/08; G06Q 20/32; G06Q 20/34; G06K 7/14; G06K 7/08; G06F 3/041

(52) U.S. Cl. CPC G06Q 20/204; G06Q 30/08; G06Q 20/201; G06F 3/041; G06Q 20/346; G06K 7/1417; G06K 7/087; G06Q 20/3274

(57) ABSTRACT

A clerking assembly for performing auction participant registration, tracking of items won, and payment therefor includes a housing, which has a microprocessor, a data storage module, and a transceiver engaged thereto and positioned therein. A card reader, a display, and a scanner are engaged to the housing and are operationally engaged to the microprocessor, along with the transceiver and the data storage module, which comprises a database. The card reader establishes an identity of a user for registration as an auction participant. The microprocessor generates a bidder number and a quick response code unique to the auction participant so that items won by the auction participant are associated thereto. The transceiver receives notification of the items won to allow updating of the database. The scanner scans the quick response code and the display presents the items associated thereto and a total cost thereof. Point of sale code enables payment processing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to clerking assemblies and more particularly pertains to a new clerking assembly for performing auction participant registration, tracking of items won, and payment therefor.

### (2) Description of Related Art Including Information Disclosed Under 37 CFR 1.97 and 1.98

The prior art relates to clerking assemblies. Prior art clerking assemblies may comprise scanners, internet interfaces, and the like.

### BRIEF SUMMARY OF THE INVENTION

An embodiment of the disclosure meets the needs presented above by generally comprising a housing, which has a microprocessor, a data storage module, and a transceiver engaged thereto and positioned therein. A card reader, a display, and a scanner are engaged to the housing. The microprocessor is operationally engaged to the data storage module, the transceiver, the card reader, the display, and the scanner. The data storage module comprises a database. The card reader is configured to read a card to establish an identity of a user to register the user in the database as an auction participant.

The microprocessor is positioned to generate a bidder number and a quick response code unique to the auction participant for entry into the database so that one or more items won by the auction participant are associated with the quick response code.

The transceiver is configured to receive notification of the one or more items won, positioning the microprocessor to update the database.

The scanner is configured to scan the quick response code, positioning the microprocessor to command the display to present the one or more items associated thereto and a total cost thereof.

Point of sale programming code positioned on the microprocessor enables the microprocessor to process payment for the one or more items to a payment card read by the card reader.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a clerking assembly according to an embodiment of the disclosure.

FIG. 2 is a side view of an embodiment of the disclosure.

FIG. 3 is a front view of an embodiment of the disclosure.

FIG. 4 is a block diagram of an embodiment of the disclosure.

### DETAILED DESCRIPTION OF THE INVENTION

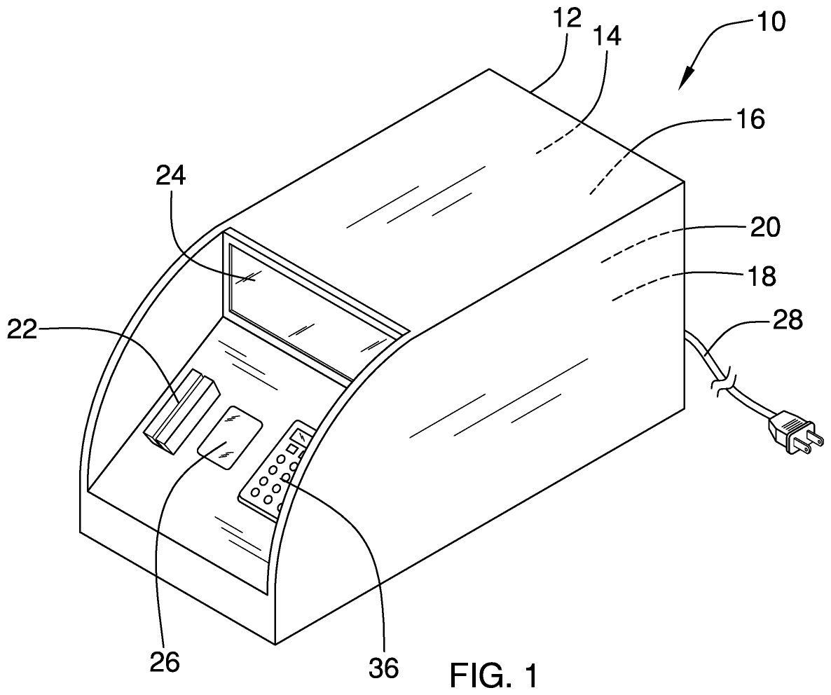

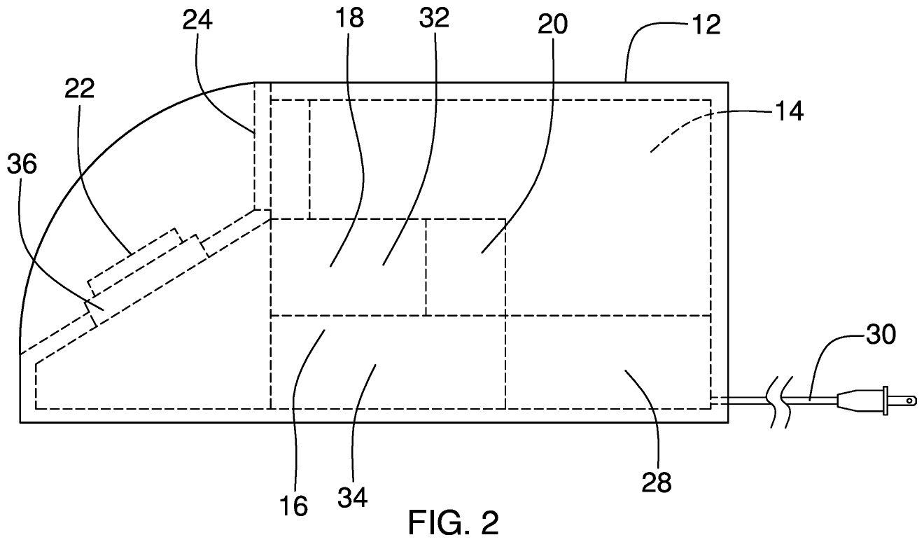

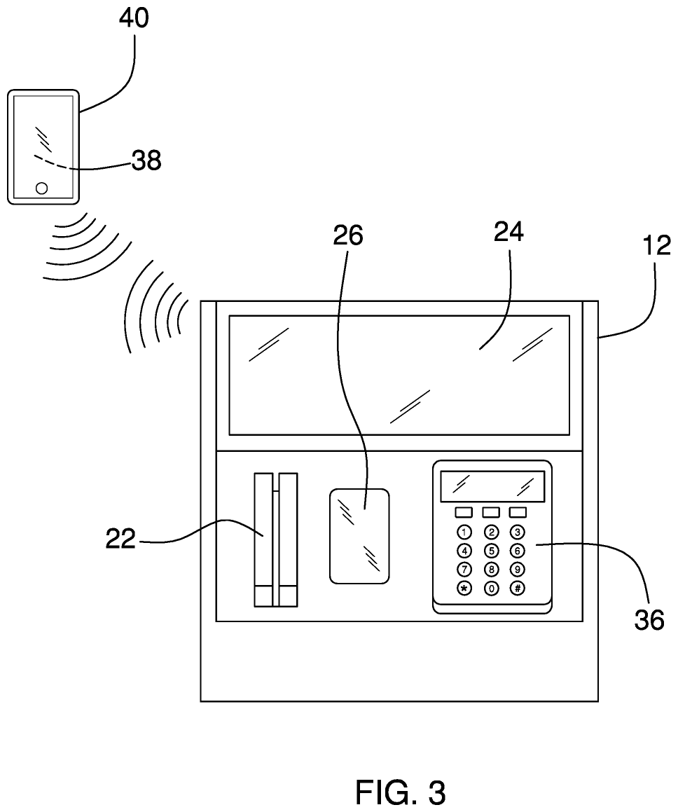

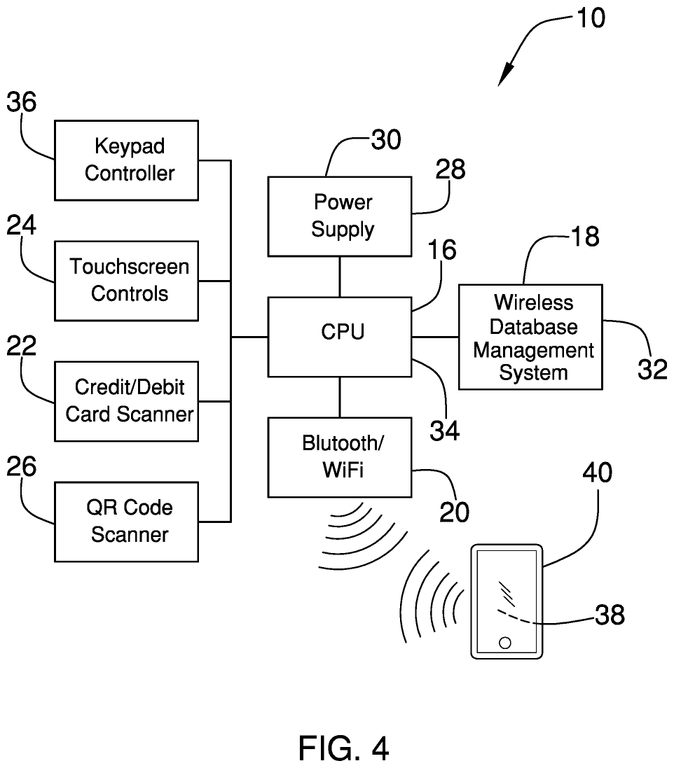

With reference now to the drawings, and in particular to FIGS. 1 through 4 thereof, a new clerking assembly embodying the principles and concepts of an embodiment of the disclosure and generally designated by the reference numeral 10 will be described.

As best illustrated in FIGS. 1 through 4, the clerking assembly 10 generally comprises a housing 12, which defines an interior space 14. A microprocessor 16, a data storage module 18, and a transceiver 20 are engaged to the housing 12 and are positioned in the interior space 14. A card reader 22, a display 24, and a scanner 26 are engaged to the housing 12. The microprocessor 16 is operationally engaged to the data storage module 18, the transceiver 20, the card reader 22, the display 24, and the scanner 26.

A power module 28 is engaged to the housing 12 and is positioned in the interior space 14. The power module 28 may comprise a power cord 30. The present invention also anticipates the power module 28 comprising a battery (not shown).

The data storage module 18 comprises a database 32. The card reader 22 is configured to read a card, such as a driver's license, credit card, and the like, to establish an identity of a user to register the user in the database 32 as an auction participant. The present invention also anticipates the database 32 being positioned on a networked computer (not shown).

The microprocessor 16 is positioned to generate a bidder number and a quick response code unique to the auction participant for entry into the database 32. One or more items won by the auction participant are associated with the quick response code.

The transceiver 20 is configured to receive notification of the one or more items won, positioning the microprocessor 16 to update the database 32.

The scanner 26 is configured to scan the quick response code, positioning the microprocessor 16 to command the display 24 to present the one or more items associated thereto and a total cost thereof.

Point of sale programming code 34 positioned on the microprocessor 16 enables the microprocessor 16 to process payment for the one or more items to a payment card read by the card reader 22.

The display 24 may be touch enabled so that the display 24 is configured for entry of data into the microprocessor 16. The housing 12 also may have a keypad 36 engaged thereto and which is operationally engaged to the microprocessor 16. The keypad 36 is configured for numerical entry into the microprocessor 16, such as entry of a pin number associated with a debit card.

The assembly 10 also may comprise application programming code 38, which is selectively positionable on an electronic device 40 of the user and which enables the electronic device to receive real time updates, via the transceiver 20, of items won at the auction. The application programming code 38 also enables the user to render payment for the one or more items won at the auction using the an electronic device 40.

In use, the housing 12 is positioned at an auction site. Users can register by inserting or swiping a card into the card reader 22 and will receive a bidder number and a quick response code that are unique. As the auction participant wins items at the auction, the items are added to the database 32. The auction participant can approach the housing 12 at any time and present the quick response code for scanning by the scanner 26. The items won and a total cost thereof will be presented on the display 24. The auction participant can pay for the items by inserting or swiping a payment card into the card reader 22.

With the application programming code 38 positioned on the electronic device 40 of the auction participant, the auction participant is positioned to receive real-time updates on items won and their cost via the transceiver 20. The auction participant also can pay for the items won using their electronic device 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A clerking assembly comprising:
a housing defining an interior space;
a microprocessor engaged to the housing and positioned in the interior space;
a data storage module engaged to the housing and positioned in the interior space, the data storage module being operationally engaged to the microprocessor, the data storage module comprising a database;
a card reader engaged to the housing and operationally engaged to the microprocessor, the card reader being configured for reading a card for establishing identity of a user for registering the user in the database as an auction participant, positioning the microprocessor for generating a bidder number and a quick response code unique to the auction participant for entry into the database, such that one or more items won by the auction participant are associated with the quick response code;
a transceiver engaged to the housing and positioned in the interior space, the transceiver being operationally engaged to the microprocessor, wherein the transceiver is configured for receiving notification of the one or more items won, positioning the microprocessor for updating the database,
a display engaged to the housing and operationally engaged to the microprocessor;
a scanner engaged to the housing and operationally engaged to the microprocessor, the scanner being configured for scanning the quick response code, positioning the microprocessor for commanding the display for presenting the one or more items associated thereto and a total cost thereof; and
point of sale programming code positioned on the microprocessor enabling the microprocessor for processing payment for the one or more items to a payment card read by the card reader.

2. The clerking assembly of claim 1, further including a power module engaged to the housing and positioned in the interior space.

3. The clerking assembly of claim 2, the power module comprises a power cord.

4. The clerking assembly of claim 1, wherein the display is touch enabled, wherein the display is configured for entry of data into the microprocessor.

5. The clerking assembly of claim 1, further including a keypad engaged to the housing and operationally engaged to the microprocessor, wherein the keypad is configured for numerical entry into the microprocessor.

6. The clerking assembly of claim 1, further including application programming code selectively positionable on an electronic device of the user enabling the electronic device for receiving real time updates, via the transceiver, of items won at the auction.

7. The clerking assembly of claim 6, wherein the application programming code enables the user for rendering payment for the one or more items won at the auction.

8. A clerking assembly comprising:
a housing defining an interior space;
a power module engaged to the housing and positioned in the interior space, the power module comprising a power cord;
a microprocessor engaged to the housing and positioned in the interior space,
a data storage module engaged to the housing and positioned in the interior space, the data storage module being operationally engaged to the microprocessor, the data storage module comprising a database;
a card reader engaged to the housing and operationally engaged to the microprocessor, the card reader being configured for reading a card for establishing identity of a user for registering the user in the database as an auction participant, positioning the microprocessor for generating a bidder number and a quick response code unique to the auction participant for entry into the database, such that one or more items won by the auction participant are associated with the quick response code;
a transceiver engaged to the housing and positioned in the interior space, the transceiver being operationally engaged to the microprocessor, wherein the transceiver is configured for receiving notification of the one or more items won, positioning the microprocessor for updating the database,
a display engaged to the housing and operationally engaged to the microprocessor, the display being touch enabled wherein the display is configured for entry of data into the microprocessor;
a scanner engaged to the housing and operationally engaged to the microprocessor, the scanner being configured for scanning the quick response code, positioning the microprocessor for commanding the display for presenting the one or more items associated thereto and a total cost thereof;
a keypad engaged to the housing and operationally engaged to the microprocessor, wherein the keypad is configured for numerical entry into the microprocessor;
point of sale programming code positioned on the microprocessor enabling the microprocessor for processing payment for the one or more items to a payment card read by the card reader; and
application programming code selectively positionable on an electronic device of the user enabling the electronic device for receiving real time updates, via the transceiver, of items won at the auction, the application programming code enabling the user for rendering payment for the one or more items won at the auction.
